(19) United States
(12) Patent Application Publication
(10) Pub. No.: US 2021/0146785 A1
(43) Pub. Date: May 20, 2021

(54) DRIVER MODEL ESTIMATION, CLASSIFICATION, AND ADAPTATION FOR RANGE PREDICTION

(71) Applicant: GM GLOBAL TECHNOLOGY OPERATIONS LLC, Detroit, MI (US)

(72) Inventors: Yue-Yun Wang, Troy, MI (US); Jun-mo Kang, Ann Arbor, MI (US); Dongxu Li, Troy, MI (US); Chunhao J. Lee, Troy, MI (US); Jinzhu Chen, Troy, MI (US); Donald K. Grimm, Utica, MI (US); David J. Brooks, Troy, MI (US)

(73) Assignee: GM GLOBAL TECHNOLOGY OPERATIONS LLC, Detroit, MI (US)

(21) Appl. No.: 16/687,927

(22) Filed: Nov. 19, 2019

(51) Int. Cl. B60L 15/20; G06N 20/00; G06N 5/04

(52) U.S. Cl. CPC B60L 15/20; G06N 20/00; G06N 5/04; B60L 2240/66; B60L 2240/64; B60L 2240/68; B60L 2250/18

(57) ABSTRACT

A method of using a control system to estimate range of an electrified vehicle operated by a driver includes monitoring a first set of driver behaviors while the vehicle is in operation and comparing the monitored first set of driver behaviors to a plurality of known profiles having respective stored behaviors. The method may include matching the first set of driver behaviors to at least one of the known profiles to create an adapted driver model, modeling an adapted drive cycle profile based on the matched adapted driver model, and calculating a predicted driving range based on the adapted drive cycle profile. The method may classify the monitored first set of driver behaviors as at least one of conservative, neutral, and aggressive, relative to the plurality of known profiles, and model the adapted drive cycle profile is further based on the conservative, neutral, or aggressive classification.

### INTRODUCTION

The present disclosure relates to range prediction, based on adaptive driver profiles, in vehicles having electric propulsion systems. Example vehicles include electric or plug-in hybrid vehicles.

### SUMMARY

A method of using a control system to estimate range of an electrified vehicle operated by a driver is provided. The method may include monitoring a first set of driver behaviors while the vehicle is in operation, and comparing the monitored first set of driver behaviors to a plurality of known profiles having respective stored behaviors.

The method may match the first set of driver behaviors to at least one of the known profiles to create an adapted driver model, and model an adapted drive cycle profile based on the matched adapted driver model. The method includes calculating a predicted driving range based on the adapted drive cycle profile.

In some configurations, the method may include classifying the electrified vehicle as at least one of: a first class, a second class, and a third class. The method may also access a cloud database to determine whether the driver has a stored driver ID.

If the cloud database does not have the stored driver ID for the same class as the electrified vehicle, the method monitors a first set of driver behaviors while the vehicle is in operation, and compares the monitored first set of driver behaviors to a plurality of known profiles having respective stored behaviors. The method matches the first set of driver behaviors to at least one of the known profiles to create an adapted driver model, and models an adapted drive cycle profile based on the matched adapted driver model. A predicted driving range is calculated based on the adapted drive cycle profile.

If the cloud database does not have the stored driver ID for the same class as the electrified vehicle, the method models the adapted drive cycle profile based on a personalized full dynamic driver model matched with the stored driver ID. That personalized full dynamic driver model is trained with sufficient data by machine learning. The predicted driving range is then calculated based on the personalized full dynamic driver model.

In some configurations, a classification model is trained by one of artificial intelligence and statistical methods based on the plurality of known profiles. If the cloud database does not have the stored driver ID for the instant electrified vehicle, the method includes classifying the monitored first set of driver behaviors as at least one of conservative, neutral, and aggressive, by comparing the first set of driver behaviors to the trained classification model.

The adapted drive cycle profile may be further based on the conservative, neutral, or aggressive classification. The method may include calculating the predicted driving range based on a predicted geospatial route for the electrified vehicle, road conditions, traffic conditions, and/or environmental conditions.

If the cloud database does not have the stored driver ID for the same class as the electrified vehicle, the method may include monitoring a second set of driver behaviors, occurring after the first set of driver behaviors, and comparing the monitored second set of driver behaviors to the known profiles. The method may update the modeled adapted drive cycle profile based on the second set of driver behaviors, and recalculate the predicted driving range based on the updated adapted drive cycle profile.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic environmental view of an exemplary motor vehicle having an electric propulsion system, such as a hybrid electric vehicle or battery electric vehicle.

FIG. 2 is a schematic flow diagram illustrating a predictive model based algorithm for estimating total electric-drive energy consumption to derive intelligent range planning, which may be varied based on predicted driver behaviors.

FIG. 3 is a schematic flow diagram illustrating interaction between the predictive model of FIG. 2 and a cloud based system for determining driver models with limited information.

FIG. 4 is a schematic flowchart diagram illustrating one possible method for determining relevant driver models, irrespective of the vehicle type, and estimating electric range based thereupon.

### DETAILED DESCRIPTION

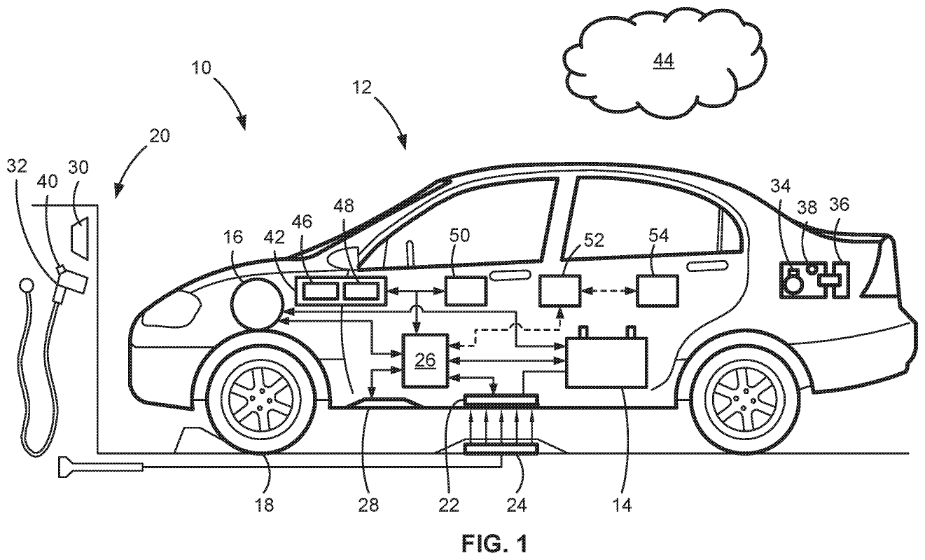

Referring to the drawings, like reference numbers refer to similar components, wherever possible. FIG. 1 schematically illustrates a side view of a motor or electrified vehicle 10, which is portrayed herein for purposes of discussion as a sedan-style, electric-drive (hybrid or electric) motor vehicle, which may simply be referred to as an electrified vehicle. Packaged within a vehicle body 12 of the vehicle 10, e.g., within a passenger compartment, a trunk compartment, or a dedicated battery compartment, is a traction battery pack 14 that is electrically coupled to, and powers, one or more electric motor-generators or electric machines 16 that operate to turn one or more of the road wheels 18 and thereby propel the vehicle 10.

The illustrated vehicle 10, which may also referred to herein as automobile or motor vehicle, is merely an example application on which aspects and features of this disclosure may be practiced. While the vehicle 10 is depicted as a car, it should be understood that the vehicle 10 may be a car, a truck, an SUV, a van, a semi, a tractor, a bus, a go-kart, or any other rolling platform without departing from the scope or intent of the present disclosure.

In the same vein, implementation of the present concepts for the specific electric vehicle supply equipment (EVSE) illustrated in FIG. 1 should also be appreciated as an exemplary application of the disclosed concepts and features. As such, it will be understood that aspects and features of this disclosure may be applied to other types of EVSE, and implemented for any logically relevant type of motor vehicle. Moreover, only selected components of the vehicle 10 and EVSE have been shown and will be described in additional detail herein. Nevertheless, the motor vehicles and EVSE architectures discussed below can include numerous additional and alternative features, and other commercially available peripheral components, for example, to carry out the various protocols and algorithms of this disclosure.

The drawings presented herein are not to scale and are provided purely for instructional purposes. Thus, the specific and relative dimensions shown in the drawings are not to be construed as limiting.

While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

When used herein, the term “substantially” refers to relationships that are, ideally perfect or complete, but where manufacturing realties prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be considered to be within 5%. When used herein, the term “instant” generally refers to the driver or vehicle at hand, as opposed to previous or other drivers or vehicle.

FIG. 1 is a simplified illustration of the electric-drive vehicle 10 docked at, and operatively coupled to, a vehicle charging station 20 for recharging an onboard rechargeable energy source, such as a high-voltage direct current (DC) traction battery pack 14. The traction battery pack 14 may take on many suitable configurations, including an array of lead-acid, lithium-ion, or other applicable types of rechargeable batteries suitable for electric vehicle batteries (EVB).

To provide an operable coupling between the traction battery pack 14 and vehicle charging station 20, the vehicle 10 may include an inductive charging component 22, with, for example, an integrated induction coil that is mounted to the underside of the vehicle body 12. This inductive charging component 22 functions as a wireless charging interface that is compatible with a wireless charging pad or platform 24, for example an internal EMF coil of the vehicle charging station 20.

In the illustrated configuration, the wireless charging platform 24 is located on the floor of the vehicle charging station 20, and is positioned in accordance with a target location that serves as a desired parking location and promotes efficient and effective wireless charging of the vehicle 10. In particular, FIG. 1 depicts the vehicle 10 parked in a location that helps to ensure the inductive charging component 22 is substantially aligned in both lateral and longitudinal dimensions with the wireless charging platform 24. Put another way, the vehicle 10 in FIG. 1 is considered to be in proper fore-aft alignment and in proper starboard-port alignment with the designated target location to complete an inductive charging event for the vehicle 10.

The vehicle charging station 20 may employ any heretofore and hereinafter developed type of wired and wireless charging technology, including, without limitation: inductive charging, radio charging, and resonance charging. In accordance with electromagnetic induction charging technology, the representative wireless charging platform 24 of FIG. 1 may be activated with electric current to generate an alternating electromagnetic field proximate the inductive charging component 22. This magnetic field, in turn, induces an electric current in the inductive charging component 22 of the vehicle 10. The induced current may be filtered, stepped-down, and/or phase-shifted by in-vehicle electrical modulation circuitry to charge the traction battery pack 14 or any other energy storage source of the vehicle 10 (for example, and without limitation, a standard 12V lead-acid starting, lighting, and ignition (SLI) battery, or an auxiliary power module).

Traction battery pack 14 stores energy that can be used for propulsion by the electric machines 16 and for operating other vehicle electrical systems. The traction battery pack 14 is operatively connected (wired or wirelessly) to one or more vehicle control systems or controllers 26, which may include an electronic control unit (ECU), that regulates the operation of various onboard vehicle components. Contactors controlled by the controller 26, for example, may isolate the traction battery pack 14 from other components when opened, and connect the traction battery pack 14 to other components when closed. The controller 26 is also communicatively connected to the electric machines 16 to control, for example, bi-directional transfer of energy between the traction battery pack 14 and each electric machine 16. For instance, traction battery pack 14 may provide a DC voltage while the electric machines 16 may operate using a three-phase AC current. In such a configuration, the controller 26, or componentry controlled thereby, converts the DC voltage to a three-phase AC current for use by the electric machines 16.

In a regenerative mode where the electric machines 16 act as generators, the controller 26 may convert three-phase AC current from the electric machines 16 to DC current compatible with the traction battery pack 14. The representative controller 26 is also shown communicating with the charging component 22, for example, and without limitation, to condition the power supplied from the vehicle charging station 20 to the battery pack 14 to help ensure proper voltage and current levels. The controller 26 may also interface or communicate with the charging station 20 to, for example, and without limitation, coordinate delivery of power to the vehicle 10.

Vehicle charging station 20 of FIG. 1 also offers wired charging for electric vehicle 10 via a plug-in electrical connector 32, which may be one of a number of different commercially available electrical connector types. For example, and without limitation, the electrical connector 32 may be a Society of Automotive Engineers (SAE) J1772 (Type 1) or J1772-2009 (Type 2) electrical connector with single or split phase modes operating at 120 to 240 volts (V) with alternating current (AC) at up to 80 amperes (A) peak current for conductive vehicle charging. Furthermore, the electrical connector 32 may also be designed to meet the standards set forth in International Electrotechnical Commission (IEC) 62196-3 Fdis and/or IEC 62196-2, as well as any other presently available or hereinafter developed standards.

A charge port 34 may be accessible on the exterior of vehicle body 12 as a wired charging interface functioning as an electrical inlet into which electrical connector 32 may be plugged or otherwise connected. The charge port 34 enables a user to easily connect and disconnect electric vehicle 10 to and from a readily available AC or DC source, such as a public utility power grid via charging station 20. The charge port 34 of FIG. 1 is not limited to any particular design, and may be any type of inlet, port, connection, socket, plug, etc., that enables conductive or other types of electrical connections. A hinged charge port door, which may be referred to as CPD 36, on the vehicle body 12 can be selectively opened and closed to access and cover the charge port 34, respectively.

As part of the charging process, the electric-drive vehicle 10 may monitor wired or wireless charging availability, power quality, and other related issues that may affect charging of the vehicle 10. According to the illustrated example, the vehicle controller 26 of FIG. 1 communicates with, and receives sensor signals, from a monitoring system, which may include one or more onboard resident sensing devices 28 of the vehicle 10 and/or one or more offboard remote sensing devices 30 of the vehicle charging station 20. In practice, the monitoring system may include a single sensor, or it may include a distributed sensor architecture with an assortment of sensors packaged at similar or alternative locations to that shown in the drawings. A CPD sensor 38 mounted by the charge port 34 may sense, and be polled or read by the vehicle's controller 26 to determine, a door status—opened or closed—of the CPD 36. As another option, a latching button 40 that helps to physically attach and secure the electrical connector 32 to the charge port 34 may include an internal switch (e.g., an SAE S3 type switch) that functions as a sensing device to detect whether or not the electrical connector 32 is operatively connected to the charge port 34.

Skilled artisans will recognize numerous other types of sensing devices that can also be used, including, without limitation: thermal sensing devices, such as passive thermal infrared sensors; optical sensing devices, such as light and laser-based sensors; acoustic sensing devices, such as surface acoustic wave (SAW) and ultrasonic sensors; or capacitive sensing devices, such as capacitive-based proximity sensors.

The representative vehicle 10 of FIG. 1 may be originally equipped with a vehicle telecommunication and information unit, which may be referred to as a telematics unit 42, that communicates with a remotely located (offboard) cloud computing system 44, which may simple be referred to as the cloud computing system 44. The telematics unit 42 may communicate, for example, and without limitation, via cell towers, base stations and/or mobile switching centers (MSCs).

These hardware components of the telematics unit 42 may also function, at least in part, as a resident vehicle navigation system, to enable assisted and/or automated vehicle navigation, and as a human machine interface (HMI), to enable a user to communicate with the telematics unit 42 and other systems and system components of the vehicle 10. Acting as both a user-input device and a vehicle-output device, the telematics unit 42 may be equipped with an electronic video display device 46 and assorted HMI input controls 48 (e.g., buttons, knobs, switches, trackpads, keyboards, touchscreens, etc.).

Other peripheral hardware may include a microphone that provides an occupant of the vehicle 10 with means to input verbal or other auditory commands, and an embedded voice-processing unit programmed with computational speech recognition software capabilities. An audio system with one or more speaker components may provide audible output to occupants and may be either a stand-alone device dedicated for use with the telematics unit 42 or may be part of a general audio system.

With continuing reference to FIG. 1, telematics unit 42 may be an onboard computing device that provides a plurality of services, both individually and through its communication with other devices of the vehicle 10. The telematics unit 42 may be generally composed of one or more processors, each of which may be embodied as, for example, and without limitation, a discrete microprocessor, an application specific integrated circuit (ASIC), or a dedicated control module. Vehicle 10 may offer centralized control via the controller 26 that is operatively coupled to one or more electronic memory devices 50, each of which may take on the form of, for example, and without limitation, a CD-ROM, magnetic disk, IC device, or a semiconductor memory (e.g., various types of RAM or ROM), and may includes a real-time clock (RTC).

Long-range connectivity and communication capabilities with remote, offboard networked devices may be provided via one or more of: a cellular chipset/component; a navigation and location chipset/component, such as a global positioning system (GPS) transceiver; or a wireless modem. The long-range communications are collectively represented at long-range componentry 52. Close-range wireless connectivity may be provided via a short-range wireless communication device, including one or more of, without limitation: a BLUETOOTH® unit; near field communications (NFC) transceiver; a dedicated short-range communications (DSRC) component; or a dual antenna. The close-range communications are collectively represented at close-range componentry 54. The various communications devices described above may be configured to exchange data as part of a periodic broadcast in a Vehicle-to-Vehicle (V2V) communication system or a vehicle-to-everything (V2X) communication system—for example, Vehicle-to-Infrastructure (V2I), Vehicle-to-Pedestrian (V2P), Vehicle-to-Device (V2D), etc.

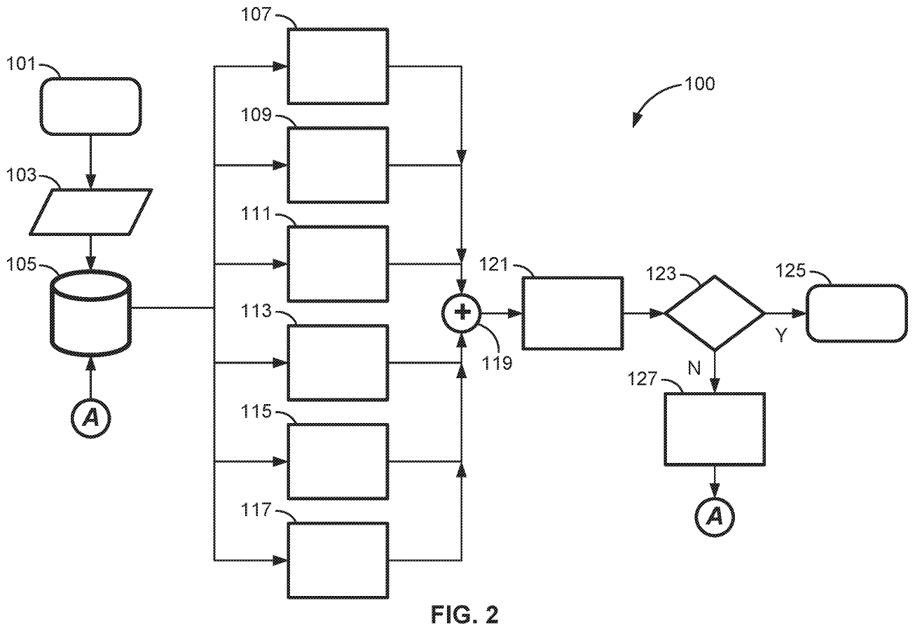

With reference to FIG. 2, and continued reference to FIG. 1, there is shown a flow diagram 100 illustrating an improved method or control strategy using artificial intelligence based (AI-based) or machine learning based (ML-based) predictive modeling for deriving total energy consumption of a full electric vehicle (FEV) for a designated route in accordance with aspects of the present disclosure. Artificial intelligence and machine learning are generally used interchangeably herein.

Some or all of the operations illustrated in FIG. 2 and described in further detail below, or other diagrams herein, may be representative of an algorithm that corresponds to processor-executable instructions that may be stored, for example, in main or auxiliary or remote memory, and executed, for example, by an on-board or remote controller, processing unit, control logic circuit, or other module or device, to perform any or all of the above or below described functions associated with the disclosed concepts. It should be recognized that the order of execution of the illustrated operation blocks is not limiting, and that the order may be changed, additional blocks may be added, and some of the blocks described may be modified, combined, or eliminated.

Flow diagram 100 begins at terminal block 101 with processor-executable instructions for a programmable controller or control module, or other suitable processor or server computer to call up an initialization procedure for a predictive charge planning protocol that provides more accurate EV travel range estimates, optimizes electrical system energy usage, and helps to increase battery operational life. This routine may be executed in real-time, continuously, systematically, sporadically and/or at regular intervals—for example, and without limitation, every 100 milliseconds during ongoing vehicle operation. As yet another option, terminal block 101 may initialize in response to a user command prompt or a broadcast prompt signal received from a backend or middleware computing node tasked with collecting, analyzing, sorting, storing and distributing vehicle data.

As part of the initialization procedure at terminal block 101, the resident vehicle telematics unit 42 may execute a navigation processing code segment to obtain vehicle data and geospatial data—including, without limitation, vehicle speed, heading, acceleration and/or vehicle axle torque, timestamp—and optionally display select aspects of this data to an occupant of the vehicle 10. The occupant may employ any of the HMI input controls 48 to then select a desired origin and/or destination for the vehicle. It is also envisioned that the ECU or controller 26 or telematics unit 42 processors receive vehicle origin and vehicle destination information from other sources, such as a server-class computer provisioning data exchanges for the cloud computing system 44, or a dedicated mobile software application operating on a smartphone or other handheld computing device.

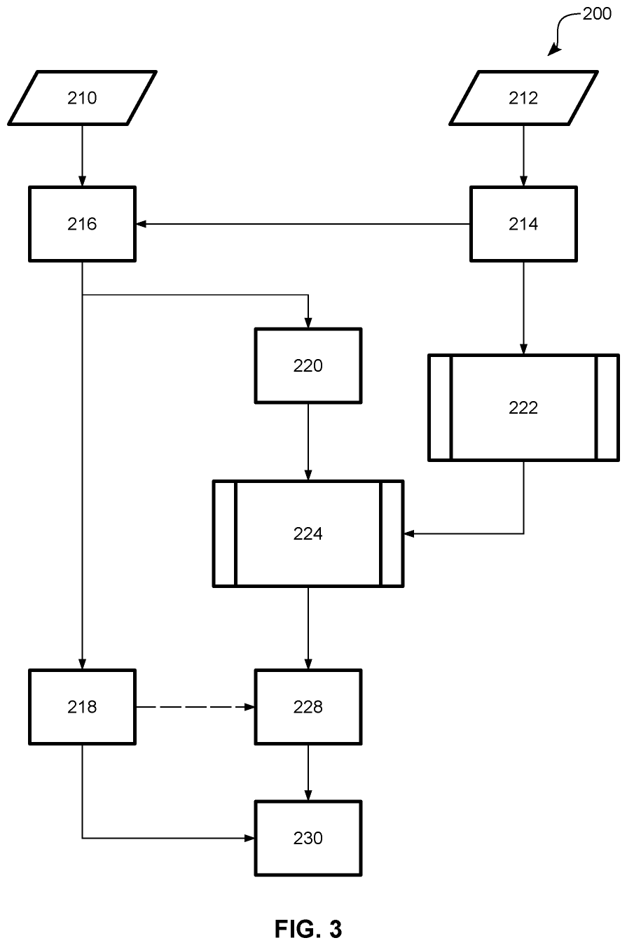

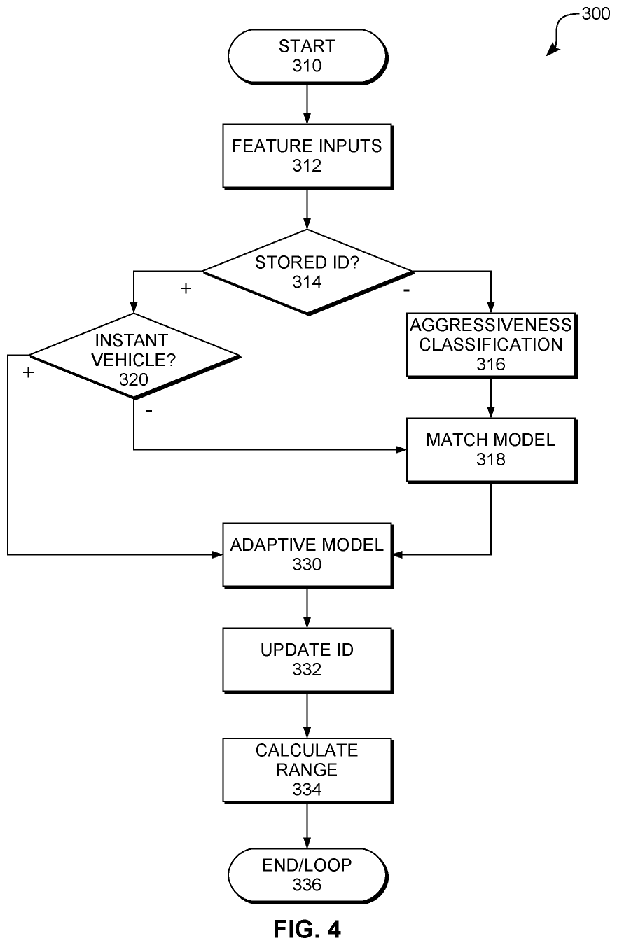

At a data block 103, the vehicle accesses an ML-based predictive model for the driver. The predictive model may be downloaded from, for example, the cloud computing system 44, any data cloud or any similar system. The ML-based predictive model may be used to estimate different types of energy consumption, based on expected driving behaviors relative to road, traffic, or weather conditions, including ambient temperature and tailwind versus headwind levels. Derivation of the ML-based predictive model is described herein, but the data block 103 may receive the model from either the processes described relative to FIGS. 3 and 4 or from a stored ID for the instant driver. The ML-based predictive model may include other preferences, such as HVAC temperature settings. The data block 103 may also be accessing other information, such as vehicle route, traffic, and environmental conditions, and the ML-based predictive model.

Once a vehicle origin (starting position) and a vehicle destination (ending position) are known or estimated, the flow diagram 100 executes a geospatial query at input/output block 105 to identify location-specific geographic information. For example, and without limitation, the query conducted at input/output block 105 may utilize a vehicle's real-time location information (i.e., a set of GPS-generated geodetic datum) and temporal information (i.e., a vehicle timestamp) to identify a designated route for traversing from the vehicle origin to vehicle destination. Geospatial information may include, in some non-limiting examples, shoulder location data, road center location data, road boundary location and geometry data, intersection midpoint location data, traffic flow speed, or regulated speed limits, etc.

Rather than identify a single route option, the geospatial query of input/output block 105 may identify multiple preview routes corresponding to the vehicle's start and end positions. Flow diagram 100 further accesses an OPENSTREETMAP® (OSM) data service, or similarly suitable mapping database, to lookup road-level data associated with each route as part of input/output block 105. This baseline road-level information may include interconnecting segments that form a given route, a name for each road segment, a speed limit for each road segment, lane alignment information, traffic light locations, stop sign positions, gradients, etc.

After establishing a vehicle origin, destination and at least one designated or preview route, and then aggregating relevant road-level data and roadway traffic and disturbance data, the flow diagram 100 begins to implement eDrive energy consumption models, auxiliary device energy consumption models, autonomous device energy consumption models, etc., to build a holistic simulation of total vehicle energy consumption to reach the desired vehicle destination. Each of these models may incorporate expected or predicted driver behaviors to better predict total vehicle energy consumption and, therefore, better predict the driving range of the vehicle.

Process block 107 provides memory-stored, processor-executable instructions to calculate a predicted motor energy usage of a traction motor (e.g., the electric machines 16 of FIG. 1) to propel an electric vehicle (e.g., electric-drive vehicle 10) across a given preview route. Predicted motor speed, ω, is a function of a predicted vehicle speed Vp and a motor speed to vehicle speed ratio k:

ω=k(r,Gr)Vp

where k is a function of gear ratio Gr and tire radius r. It may be desirable to determine a given driver model for the driver to help predict vehicle speed, desired propulsion torque, and other dynamic driving behaviors for a given route. Mechanisms for determining an applicable driver model, based on monitoring primary inputs from the driver and communication with the cloud computing system 44, are discussed herein.

Determining the driver model may include deep learning neural network (DNN) techniques. It should be appreciated, however, that other forms of driver models may be utilized, including Long Short Term Memory (LSTM) neural network models, statistical models (e.g., Markov chain), Hidden Markov Model (HMM), nonlinear regression models, etc.

From a predicted desired propulsion torque Tq_{des} estimated through an ML-based driver model, the system is able to calculate a predicted motor torque T_{MGU}(A:B) for the preview route under investigation. Through integration, the system calculates a predicted total motor energy usage as E_{MGU}:

E_{MGU}=∫_{A}^{B}ωT_{MGU}dt−E_{RGN}

where A and B are indicia of the vehicle origin and vehicle destination, respectively, and E_{RGN} is a total regenerated energy for the preview route.

During a braking operation, the ECU or controller 26, such as through implementation of a motor control module (MCM) and battery control module (BCM), may operate the electric machines 16 to recover energy from slowing the vehicle 10 and store the energy in the EVB traction battery pack 14 through a regenerative braking operation. Actual motor energy usage may be higher than a predicted total motor energy usage E_{MGU} since the motor is likely not 100% efficient. To correct for this issue, predicted total motor energy usage E_{MGU} can be divided by an η term, which is a function of motor speed or torque, and accounts for imperfect efficiency.

At process block 109, the flow diagram 100 calculates an inverter/converter energy loss as a function of the predicted motor speed and predicted motor torque. Such inverter/converter energy loss results from the electrified powertrain employing a power inverter module or an AC-DC converter to operate the traction motor and battery pack during the designated route.

Vehicle 10 may employ a power inverter module to modulate a DC voltage received from the traction battery pack 14, and output an AC voltage suitable for powering the electric machines 16. By comparison, an AC-DC converter may be used as a battery charger or onboard charging module (OBCM) to convert AC charging power from an offboard AC power supply (e.g., the vehicle charging station 20), or the AC voltage from the electric machines 16 operating in regenerative mode into a DC voltage suitable for use by the battery pack 14 and other DC devices.

Flow diagram 100 then calculates a motor energy loss as a function of predicted motor speed and torque at process block 111. Motor energy losses may result from several factors, such as: (1) resistive losses in the stator windings; (2) hysteresis losses in the stator cores; and (3) uncaptured high-frequency electrical energy reflected back from the coils.

The inverter/converter energy loss calculated at process block 109 and the motor energy loss calculated at process block 111 may both be affected by different driving styles or behaviors of different drivers. Therefore, the flow diagram 100 is varying the calculations through the ML-based driver model from data block 103 that is estimating the behaviors of the driver of the vehicle 10.

With continuing reference to FIG. 2, an estimated total energy usage of a vehicle heating, ventilation, and air conditioning (HVAC) system is calculated at process block 113. For example, the vehicle 10 may employ a refrigerant-based compressor for cooling air injected into the passenger compartment, while electrically resistant metallic heat strips or heated coolant by a high voltage heater may be provided for heating air and the battery. In addition to powering the air compressor and heat strips, electrical energy is consumed to operate blowers or fans that circulate the heated/cooled air into the passenger compartment and other desired sections of the vehicle body 12.

Total vehicle energy consumption may also account for auxiliary device energy needed to power peripheral electronics operated over the duration of the designated route at process block 115. Such auxiliary, or non-vehicle-propulsion, equipment may include a DC-DC converter for converting high voltage power from the traction battery pack 14 to a low voltage power for running various electrical components in the vehicle, such as a radio, a center console display, an electronic instrument cluster, etc. In this regard, a 12V battery load may be reserved for operating any of the non-propulsion peripheral hardware present in the vehicle 10, including auxiliary (aux) input jacks provided throughout the passenger compartment as standardized communication ports for interfacing an occupant's handheld electronics and personal computing devices with the vehicle 10.

In addition to the electrical loads enumerated above, the flow diagram 100 may also account for the energy usage of electronic devices employed to provision autonomous driving and Advanced Driver Assistance System (ADAS) functionality at process block 117. These loads may include, without limitation: dynamics sensors, radar sensing components, Lidar, cameras, and computer processors.

The HVAC loads calculated at process block 113, the auxiliary device energy needed calculated at process block 115, and the ADAS functionality at process block 117 may all be affected by different driving styles or behaviors of different drivers. Therefore, the flow diagram 100 is varying the calculations through the ML-based driver model from data block 103 that is estimating and predicting the behaviors of the driver of the vehicle 10.

Each of the calculations executed at process blocks 107, 109, 111, 113, 115 and 117 are affected by different driving styles or behaviors of different drivers. Furthermore, environmental conditions may alter the energy consumption calculated by these process blocks. For example, and without limitation, HVAC loads, rolling resistance of the tires, and energy consumption of the electric machines 16 may vary based on the ambient temperature at different points along the predicted route. Additionally, road conditions and traffic conditions, and the driver's predicted responses thereto, will alter the energy consumption calculated by these process blocks.

Therefore, the flow diagram 100 is varying the calculations through the ML-based driver model from data block 103 based on estimating the behaviors of the driver of the vehicle 10 in light of several outside factors. By incorporating predicted driver behaviors—including those affected by the planned route, traffic conditions road conditions, and environmental conditions—the process is better able derive a more accurate prediction of total energy usage.

Flow diagram 100 continues to summation operation 119 with processor-executable instructions to aggregate all predicted values of the ML-based energy consumption models executed at process blocks 107, 109, 111, 113, 115 and 117, and thereby derive a predicted total energy usage Ep(A:B). Once amassed, total energy usage Ep(A:B) is applied at process block 121 to calculate an estimated remaining battery energy ΔE of the traction battery pack 14 when the vehicle 10 reaches its destination. Remaining battery energy ΔE may be calculated as:

$$Δ E = \frac{Q}{100} {\int }_{a}^{SOC ( A )} {V}_{oc} ( SOC ) dSOC \text{-} Ep ( A \text{:} B ) \text{-} {E ( T )}_{battloss}$$

where a is a calibrated minimum battery SOC to maintain a traction battery pack in a healthy state, SOC(A) indicates a current SOC at a current location A, V_{OC}(SOC) is an open circuit voltage of the traction battery pack as a function of SOC, E(T)_{battloss} is a battery energy loss of the traction battery pack as a function of battery temperature T, and Q is the battery pack energy capacity. In this example, the first integration ∫ₐ^{SOC(A)}V_{oc}(SOC)dSOC calculates an estimated remaining battery energy of the traction battery pack 14 at the vehicle's current location A or, when not synonymous, at the desired route's starting position, used all the way to the minimum energy a being sustained.

Alternatively, an estimated remaining battery energy ΔE may be calculated as:

ΔE=(SOC(A)−a)Q−Ep(A:B)−E(T)_{battloss}

If the SOC of a battery is known, the battery energy in terms of Ampere-hours (Ah) may be calculated as a Total Capacity*% SOC. Battery open circuit voltage V_{OC} is a strong function of SOC, which makes the integral nonlinear; open circuit voltage V_{OC} may be considered to have a one-to-one relationship with SOC.

After calculating the remaining battery energy ΔE, flow diagram 100 continues to decision block 123 to determine if there is a sufficient amount of battery power for the vehicle 10 to reach the desired destination along the current designated route with the predicted driver behaviors. This determination may generally include ascertaining whether or not the current SOC of the traction battery pack 14 is greater than the predicted total energy usage by at least a calibrated percentage or value. In a more specific example, decision block 123 will ascertain whether or not the predicted remaining battery energy ΔE is greater than a calibrated charge sustaining value Thd, which is derived experimentally to prevent the traction battery pack 14 from fully discharging and, thus, helping to maintain a longer battery life cycle.

Responsive to a determination that the remaining battery energy ΔE is likely greater than the calibrated charge sustaining value Thd and, thus, there is sufficient battery power for the vehicle 10 to reach the desired destination using the designated route (decision block 123=YES), the flow diagram 100 may proceed to terminal block 125 and thereafter terminate without taking any preventative or remediating action. The flow diagram 100 may thereafter loop back to terminal block 101 and run in a continuous or iterative loop.

Conversely, upon determining that the remaining battery energy ΔE is not greater than the calibrated charge sustaining value Thd and, thus, there is an insufficient amount of battery energy for the vehicle 10 to reach the desired destination, before the next charging station, using the designated route (block 123=NO), the flow diagram 100 proceeds to process block 127, which includes memory-stored, processor-executable instructions for the resident vehicle controller 26 to automatically issue one or more command signals to a resident vehicle subsystem to execute one or more preventative or remediating control operations.

For example, and without limitation, the flow diagram 100 may return to input/output block 105 to retrieve and/or recalculate road-level data associated with one or more alternative routes (reroutes). Each of the alternative routes may be evaluated as a respective preview route in accordance with remainder of the flow diagram 100 of FIG. 2. Vehicle telematics unit 42 may concomitantly display the original designated route with one or more of the alternative routes contemporaneous with an indication that the current SOC is likely insufficient for the vehicle 10 to reach the destination using the designated route.

As an additional or alternative option, process block 127 may provide instructions for the ECU or controller 26 to coordinate with a powertrain control module (PCM) to implement a set of enhanced low-energy-consumption driving rules, such as setting the vehicle 10 into an “eco-driver mode” that limits vehicle speed and motor torque. In this regard, the ADAS module may automate one or more predetermined driving maneuvers to help preserve battery charge, including initiating adaptive cruise control (ACC) set at a calibrated speed that has been verified to optimize battery usage.

It may be desirable, for at least some applications, to disable full autonomous driving of the vehicle 10 for the duration of the route. This will eliminate the additional toll placed on the vehicle's electrical system to power the various sensors, hardware components and processors necessary to automate vehicle driving. Total motor/vehicle energy usage for each preview route may be saved in a resident or remote memory-stored map database. Optionally, the resident vehicle navigation system's display device may display each route with an indication of its corresponding total motor/vehicle energy usage.

Referring to FIG. 3, and with continued reference to FIGS. 1 and 2, there is shown a flow diagram or process 200 illustrating processes for driver classification and adaptive learning to establish an adapted driver model that more effectively predicts driver behaviors. The adapted driver model may be used to create an adapted drive cycle profile, which will better predict energy usage by the vehicle and better estimate vehicle range. The adapted drive cycle profile predicts behaviors of the driver throughout the entire drive, and may include outside effects (such as weather, traffic, etc.). The flow diagram may be used with the structures shown in FIG. 1 and may output some of its data to other processes, such as those illustrated in FIG. 2 or elsewhere.

The process 200 includes at least two input feeds, driver inputs 210 and vehicle population inputs 212. The driver inputs 210 may include the use of feature inputs directly monitoring actions of the driver. The feature inputs include, without limitation: vehicle speed and acceleration, pedal position and pedal position change rate, braking, sailing, steering angle, and speed relative to the speed limit (i.e., variation over speed limit).

Additionally, driver preference, vehicle status, and environmental inputs may be incorporated into the driver inputs 210. These secondary inputs are associated to behavior of the driver, and may affect energy usage of the vehicle. For example, and without limitation, the ambient temperature, altitude, current status of the HVAC system, and other system settings (such as eco mode cruise control) may be incorporated into the driver inputs 210.

The population inputs 212 are stored in a data cloud or cloud database 214, and include previously developed or recorded driver models classified into the groups of different driving styles for specific vehicles. Therefore, the cloud database 214 has a plurality of known profiles or models with respective stored behaviors that are associated to a particular driver to predict vehicle energy consumption. These known models may include AI-based or ML-based driver models and the operating behaviors of one or more of the individual drivers, and are formed from the population inputs 212.

The cloud database 214 may be the same as, or linked to, the cloud computing system 44 of FIG. 1, or may be a separate system. For example, and without limitation, the cloud database 214 and the cloud computing system 44 may be incorporated into, or in communication with, a proprietary communications service, such as ONSTAR®.

Note that the population inputs 212 may be differentiated based on the specific vehicle used or on more-limited vehicle classifications. For example, and without limitation, specific vehicle types, such as a first class, a second class, and a third class, may differentiate the population inputs 212. The classes may be differentiated by, without limitation: sedan A, sedan B, large SUV A, or large SUV B, or by more general vehicle categories, such as truck, SUV, or car. Note that additional categories may be used, and that numerous different specific vehicle indicators may be used, including specific trim levels or powertrain configurations, within the same vehicle type.

The population inputs 212 may be recorded behaviors, which can be sorted and/or processed via big data techniques, or may be recorded ML-based driver models. The characteristics of the population inputs 212 are stored in the cloud database 214, such that they may be accessed by other processes within the process 200. The cloud database 214 operates as both an input and output, as it both receives information from, and outputs information to, the remainder of the processes within the process 200.

Anonymous driver indicators or tags may identify the individual driver models stored in the cloud database 214. Therefore, the process 200 may use the cloud database 214 to compare anonymous behaviors to those of the instant driver. Alternatively, other steps or mechanisms may separate driver ID numbers and any recognizable data from the remainder of the process 200.

The population inputs 212 act as descriptors of possible driver behaviors and/or driver models that may be applied to the instant driver. Therefore, the population inputs 212 provide a storehouse of numerous driver behaviors to the cloud database 214. These driver behaviors or models may then be used by other portions of the process 200 to correlate to the currently sensed or recorded current driver behaviors of the vehicle 10.

At a driver ID block 216, the process 200 determines whether the driver has a stored driver ID—i.e., preexisting driver identification information or a preexisting driver profile—and to which vehicle, if any, that stored driver ID applies. For example, the driver may sign into the telematics unit 42, which may communicate with the cloud computing system 44 or the cloud database 214 to retrieve a stored driver ID.

If the stored driver ID shows that the driver already has a driver model for his regularly driven vehicle, or a substantially similar vehicle, then the process 200 knows that it has the ability to identify expected driver behaviors and apply them to the vehicle 10. Based on that stored ID, the process 200 understands that it can access or create a dynamic full driver model in a driver model block 218. This personalized full dynamic driver model is pulled from the stored ID for the instant driver.

The full dynamic driver model implemented in the driver model block 218 can be trained with sufficient data by machine learning, such as through sufficient history from the driver ID block 216. For identified drivers, the dynamic full driver model may be used to predict driver behaviors and, therefore, to predict the energy needed for the planned drive cycle.

In some situations, the driver ID block 216 may determine that the stored driver ID applies to a different vehicle type. In such a case, the process 200 may still use that model to predict driver behaviors. Alternatively, as explained herein, the process 200 may use the stored driver ID for another vehicle as a base or starting point for deriving a new ML-based driver model for the instant vehicle.

Use of ML-based driver models to predict driving behaviors and to predict driving range therefrom is explained with reference to FIG. 2. Additional information regarding range prediction from driving behavior and/or from ML-based driver models may be found in U.S. patent application Ser. No. 16/116,129, filed Aug. 29, 2018, which is hereby incorporated by reference in its entirety. Skilled artisans will recognize that recorded ML-based driver models, and the driving behaviors used to form those models, may also be the source of some of the information forming the population inputs 212.

In many situations, the driver ID block 216 may determine that there is no driver ID available, such as when the driver has not previously driven a vehicle within the system or does not register into the system. Complete lack of driver ID may be referred to as a cold start driver profile. Additionally, the driver ID block 216 may determine that the stored driver ID applies to a different vehicle or different vehicle category. In these situations, the driver ID block 216 may ask interactive questions using, for example: the HMI input controls 48, in-vehicle voice communication, or mobile applications. These questions may allow the driver to self-identify if it is a sport (aggressive) driver, a normal (neutral) driver, or an eco (conservative) driver. Based on this input and other available information from the driver, the driver is initially classified into a driving category.

The process 200 uses a behavior block 220, a model training block 222, and a matching block 224 to characterize and identify an ML-based, AI-based, or statistics-based driver model for the cold start driver profile. The behavior block 220 monitors driver behaviors, particularly when there is no stored driver ID or the stored driver ID matches another vehicle. The model training block 222 trains a classification model using feature input data collected from a large population of vehicles in the same vehicle category. Skilled artisans will recognize that, large populations are sufficient in size to train the model, and may be as low as hundreds of vehicles but will likely include thousands of vehicles. The matching block 224 correlates the monitored driver behaviors to the models with the model training block 222.

The behavior block 220 may monitor feature inputs while the vehicle is in operation to obtain information regarding the driving style, such as on an aggressiveness scale. By using the feature inputs, the process 200 is monitoring and identifying actual behaviors of the instant driver, which it may then use to derive, estimate, or correlate relevant ML-based driver models.

The process 200 uses the model training block 222 to train a classification model using feature input data collected from a large population of vehicles in the same vehicle category. The model training block 222 uses the population inputs 212 from a large population of vehicle data, including individual driver behaviors from those vehicles, to classify the driving styles for the vehicle population, and may be incorporated into the cloud database 214 or may be part of a separate computing system. The trained model can correlate similar DNA driver behaviors and classify them into an aggressiveness scale based on the whole population. As used herein, similar DNA refers to matching similar driving characteristics or profiles. The model training may be executed by big data, artificial intelligence (AI), or machine learning (ML) techniques, such as deep learning neural networks, principle component analysis techniques, as would be recognized by skilled artisans.

The matching block 224 uses the feature inputs from the behavior block 220 and the classification model of the model training block 222 to identify the instant driver on the aggressiveness scale relative to the vehicle population. Based on the new classification, the similar DNA driver behavior models may then be used as a model to estimate behaviors of the instant driver, and to predict driving range therefrom, even when little or no stored ID information existed.

The aggressiveness scale may include, for example, and without limitation: a three level differentiation or a five level differentiation. The three level aggressiveness scale may categorize the driver behaviors as one of aggressive, neutral, or conservative—with additional categories possible. Similarly, the five level aggressiveness scale may categorize the driver behaviors with integers, for example −2, −1, 0, 1, or 2, with −2 representing the most aggressive drivers and 2 representing the most conservative drivers.

The methods using feature inputs for driver behavior classification can use, for example and without limitation: neural network, the technique of principle component analysis, or statistics analysis. Principle component analysis may use the largest singular value of a covariance matrix [X.X^{T}] to classify the level of aggressiveness, where X is a matrix, and its columns are time series observations of feature inputs, such as vehicle acceleration, acceleration pedal change rate, over speed limits, etc.

After classifying the driver behaviors, the process 200 uses the matching block 224 to correlate the driver behaviors to the vehicle-specific classified driver models of the model training block 222, based on the aggressiveness classification determined by the behavior block 220. The matching block 224 provides the base point determination for the personalized and vehicle-specific classified model, which may be later altered as more driving data from the instant driver is available. For example, the behavior block 220 may determine that the driver is mildly aggressive (−1), and the matching block 224 will then pull a predetermined vehicle-specific classified model for mildly aggressive drivers of the instant vehicle category—i.e., a mildly aggressive SUV driver model—from the model training block 222.

In situations where the driver ID matches a different vehicle class, such as when the instant vehicle is an SUV but the driver normally drives a car, the matching block 224 may use the driver's known aggressiveness category and match that to the predetermined vehicle-specific classified model for the instant vehicle category from the model training block 222. For example, if the instant driver is a mildly conservative (+1) driver of a car, the matching block 224 may pull the predetermined driver profile for mildly conservative drivers of an SUV.

In some configurations, a modification block 228 may alter the vehicle-specific classified model for the instant vehicle category from the model training block 222. In particular, the process 200 may modify the basic vehicle-specific classified model, particularly when transferred from another vehicle. For example, and without limitation, a mildly conservative driver of a car may be determined, based on information from the driver inputs 210, to be a neutral or mildly aggressive driver of an SUV, particularly if that SUV is a rental vehicle. Therefore, modification block 228 may modify the vehicle-specific classified model based on correlating or pairing the actual behaviors of the instant driver to the population inputs 212 stored in the cloud database 214 and derived by the model training block 222.

In some configurations, when the process 200 has collected sufficient driving history data through the driver inputs 210, the modification block 228 may directly learn the instant driver behaviors or train the vehicle-specific driver model through machine learning. The behavior block 220 may then confirm—such as during subsequent loops of the process 200 with additional sets of driver behaviors—that the driver inputs 210 generally conform to the behaviors associated with the stored driver ID that created the dynamic full driver model. If those behaviors suggest a different driver model—for example, one driver logs into the vehicle but another driver actually takes the wheel—the behavior block 220, model training block 222, and matching block 224 may use the information in the cloud database 214 to either alter the dynamic full driver model or may try to correlate the instant driver behaviors to an entirely new model.

In an output block 230, the process 200 outputs an adapted driver model from the modification block 228 and/or an updated driver ID for use by the vehicle 10 and for storage in the cloud database 214. The updated driver ID may include the newly monitored behaviors of the driver, possibly updated to include a new vehicle, or may include the correlated driver model determined by matching block 224 and/or the adjusted model from the modification block 228. The adapted driver model may be used for improved calculation of driving range, particularly for full electric vehicles (but also for hybrid vehicles).

Referring to FIG. 4, and with continued reference to FIGS. 1-3, there is shown a flow chart illustrating a process, algorithm, or method 300 for driver classification and adaptive learning to establish the adapted driver model and use it to calculate driving range. The method 300 may include similar elements to the process 200 shown in FIG. 2, but illustrates one example of stepwise flow that may be followed by the vehicle 10, or another vehicle having sufficient resources. Any components not explicitly referenced may be assumed to be part of the vehicle 10, or another suitable vehicle, as will be recognized by skilled artisans.

The method 300 may be executed by one or more vehicle control systems, such as the controller 26, which includes sufficient computation, executive, and communication capabilities to determine and implement any of the processes, methods, or algorithms described herein. The steps illustrated in FIG. 4 are exemplary of one specific algorithm or process and are not limiting—no steps are required, and any steps may be optional, whether or not identified as such. The order of the steps or processes shown is also not limiting, and, as recognized by skilled artisans, steps may be reordered or realigned.

Step 310: Start/Initialize

The method 300 may begin operation only when called upon by the controller 26. For example, the method 300 may initialize whenever the vehicle 10 is turned on, unlocked, or opened. The method 300 may run only when specifically called, may be constantly running, or may be looping iteratively.

Numerous elements within the method 300 may be communicating with offboard systems, such as the cloud computing system 44, the cloud database 214, or the ONSTAR® network. However, the inputs received from, and the outputs sent to, the offboard systems are not separately illustrated in the flow chart. Skilled artisans will recognize the processes that include communication with the offboard systems, particularly cloud systems.

Step 312: Monitor Feature Inputs

The method 300 reads and/or analyzes feature inputs as the driver begins driving the instant vehicle. These feature inputs—such as vehicle speed and acceleration, pedal position and change, braking, sailing, steering angle, and speed relative to the speed limit—allow the method 300 to monitor or determine at least a first set of driver behaviors.

Step 314: Stored ID?

At, or soon after initiation, the method 300 checks whether the driver of the instant vehicle has a stored driver ID or preexisting driver profile. The stored driver ID may be used to access driving history, including aggressiveness classifications, vehicle history, and any previously developed ML-based driver models or statistical or other type of driver models that exist for that stored driver ID.

Step 316: Aggressiveness Classification

Where there is no stored driver ID, the method 300 uses the feature inputs to classify the first set of driving behaviors on an aggressiveness scale. The aggressiveness scale may have three levels (aggressive, neutral, or conservative), five levels (−2, −1, 0, 1, or 2), or other classification groupings, including sliding scales or bell curves with nearly infinite differentiations. This comparison and aggressiveness classification may utilize some of the techniques discussed relative to the model training block 222 of FIG. 3, where a classification model is trained using feature input data collected from a large population of vehicles in the same vehicle category, and possibly from other categories.

Step 318: Match Model

After determining the aggressiveness classification, the method 300 finds a basic, or starting, model for the instant vehicle that matches the aggressiveness classification. The method compares the monitored first set of driver behaviors from the feature inputs to a plurality of known profiles having respective stored behaviors and matches those driver behaviors to at least one of the known profiles to create a base adapted driver model. Matching may include downloading a predetermined driver model from the cloud, or the basic models—particularly where there are three classifications—may be stored onboard the vehicle.

Step 320: ID for Instant Vehicle?

Where step 314 determines that the driver does have a stored ID, the method 300 determines whether the stored ID applies to the instant vehicle. If the stored ID applies to a different vehicle type, the method 300 proceeds back to step 318 to match a base model to the driver's stored behavior profile by comparing the driver's known behaviors to the known profiles stored within the cloud.

The known aggressiveness classification associated with the stored ID may be used to find a basic driver model that correlates to the instant vehicle. For example, if the stored ID shows that the driver is a mildly conservative in her or his regular car, the method 300 may pull the basic driver model for mildly conservative drivers of the instant vehicle.

Where the driver has a stored ID for the instant vehicle, the method 300 has, or is able to access from the cloud, a model derived from the driver's previous behaviors. The stored model acts as the base model.

Step 330: Adaptive Model

After finding a base model for the driver, the method 300 proceeds to adaptive modeling, which may be used to improve the base model by better predicting driver behaviors. With continuous, or looping, monitoring of the feature inputs, the method 300 may adapt the base model—whether determined by matching to the aggressiveness classifications or from the stored driver ID—as a result of differing driver behaviors. The method 300 may correlate the characteristics of the feature inputs to similar DNA driver behavior models, and incorporate the similar DNA models into the adapted model.

Alternatively, the method 300 may simply modify or adjust the previously determined base model. For example, where the driver's stored ID shows a neutral driver of a car, but the feature inputs suggest mildly aggressive behavior in the instant car, the method 300 may slightly modify the adaptive model to be more aggressive, but not move all the way to a mildly aggressive driver profile, because the initial behaviors may be an aberration. From the adapted driver model, the method 300 models an adapted drive cycle profile that predicts driver behaviors along the predicted geospatial route.

The adaptive modeling process may be self-looping or iterating, such that it monitors feature inputs until sufficiently certain of the driver behaviors. Alternatively, subsequent loops of the method 300 will utilize that adapted model as a starting point.

Step 332: Update ID and Model

After creating the adaptive model, the method 300 proceeds to update the driver's stored ID, which may include replacing the previous base model with the adapted model determined at step 330. The updated ID may be sent to the cloud, such that it may be used with future vehicles. Additionally, the method 300 may update the onboard control system, such that the adapted model may be used for subsequent calculations.

Step 334: Estimate Range from Dynamic Model

The method 300 then uses the newly updated base model, from the adapted model of step 330, to estimate the driving range of the instant vehicle. This includes modeling the adapted drive cycle profile for the entire route, such as discussed relative to FIG. 2, relative to the determined aggressiveness classification. By integrating the expected individual behaviors over the predicted route, the method 300 is able to estimate the total energy usage over the predicted route and is able to calculate the predicted driving range of the vehicle. Estimating range from the full dynamic model may include, without limitation, predicting driver responses to: road conditions, traffic conditions, and/or environmental conditions.

Step 336: End/Loop

After estimating the driving range of the vehicle, the method 300 proceeds to either end or loop. In many configurations, the method 300 will loop constantly, possibly at a regular interval, while the vehicle is operational.

The detailed description and the drawings or figures are supportive and descriptive of the subject matter herein. While some of the best modes and other embodiments have been described in detail, various alternative designs, embodiments, and configurations exist.

Furthermore, any embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method of using a control system to estimate range of an electrified vehicle operated by a driver, comprising:
monitoring a first set of driver behaviors while the vehicle is in operation;
comparing the monitored first set of driver behaviors to a plurality of known profiles having respective stored behaviors;
matching the first set of driver behaviors to at least one of the known profiles to create an adapted driver model;
modeling an adapted drive cycle profile based on the adapted driver model; and
calculating a predicted driving range of the electrified vehicle based on the adapted drive cycle profile.

2. The method of claim 1, further comprising:
classifying the monitored first set of driver behaviors as one of conservative, neutral, or aggressive, relative to the plurality of known profiles; and
wherein modeling the adapted drive cycle profile is further based on the conservative, neutral, or aggressive classification.

3. The method of claim 2:
wherein classifying the monitored first set of driver behaviors includes performing classification using one of artificial intelligence or principle component analysis based on time series observations of feature inputs from the vehicle, and
wherein the feature inputs include one or more of: acceleration, speed, braking, pedal position, pedal position change rate, variation over speed limit, or steering angle.

4. The method of claim 3:
wherein the known profiles are located in a cloud computing system that is in communication with the electrified vehicle, and
accessing the known profiles from the cloud computing system.

5. The method of claim 1, further comprising:
determining whether the driver has a preexisting driver profile; and
if the driver does not have the preexisting driver profile, modeling the adapted drive cycle profile based on matching the first set of driver behaviors to the known profiles; and
if the driver does have the preexisting driver profile, modeling the adapted drive cycle profile based on the preexisting driver profile.

6. The method of claim 1, further calculating the predicted driving range based on a predicted geospatial route for the electrified vehicle.

7. The method of claim 6, further calculating the predicted driving range based on:
road conditions;
traffic conditions; and
environmental conditions.

8. The method of claim 1, further comprising:
monitoring a second set of driver behaviors, occurring after the first set of driver behaviors;
comparing the monitored second set of driver behaviors to the known profiles;
updating the adapted drive cycle profile based on comparison of the second set of driver behaviors to the known profiles; and
recalculating the predicted driving range based on the updated adapted drive cycle profile.

9. The method of claim 1, further comprising:
determining whether the driver has a preexisting driver profile;
classifying the electrified vehicle within an instant vehicle class, including one of: a first class, a second class, or a third class; and
if the preexisting driver profile is for a vehicle in a different class, matching the preexisting driver profile to one of the known profiles that matches the instant vehicle class.

10. The method of claim 9, further comprising:
classifying the preexisting driver profile on an aggressiveness scale including, at least: conservative, neutral, and aggressive; and
matching the preexisting driver profile to one of the known profiles that matches the instant vehicle class and that matches the aggressiveness scale for the preexisting driver profile.

11. The method of claim 1, further comprising:
training a classification model by one of artificial intelligence and statistical methods based on the plurality of known profiles, where the known profiles include individual driver inputs from a large vehicle population; and
classifying the monitored first set of driver behaviors as one of conservative, neutral, or aggressive, by comparing the first set of driver behaviors to the trained classification model,
wherein modeling the adapted drive cycle profile is further based on the conservative, neutral, or aggressive classification.

12. The method of claim 11, further calculating the predicted driving range based on:
a predicted geospatial route for the electrified vehicle;
road conditions;
traffic conditions; and
environmental conditions.

13. The method of claim 12, further comprising:
monitoring a second set of driver behaviors, occurring after the first set of driver behaviors;
comparing the monitored second set of driver behaviors to the known profiles;
updating the adapted drive cycle profile based on comparison of the second set of driver behaviors to the known profiles; and
recalculating the predicted driving range based on the updated adapted drive cycle profile.

14. The method of claim 13:
wherein the known profiles and the classification model are located in a cloud computing system that is in communication with the electrified vehicle, and
accessing the known profiles and the classification model from the cloud computing system.

15. A method of using a control system to estimate range of an electrified vehicle operated by a driver, comprising:
accessing a cloud database to determine whether the driver has a stored driver ID;
classifying the electrified vehicle as one of: a first class, a second class, or a third class;
if the cloud database does not have the stored driver ID for the class of the electrified vehicle:
monitoring a first set of driver behaviors while the vehicle is in operation;
comparing the monitored first set of driver behaviors to a plurality of known profiles having respective stored behaviors;
correlating the first set of driver behaviors to at least one of the known profiles to create an adapted driver model;
modeling an adapted drive cycle profile based on the adapted driver model; and
calculating a predicted driving range based on the adapted drive cycle profile; and
if the cloud database does not have the stored driver ID for the class of the electrified vehicle:
modeling the adapted drive cycle profile based on a personalized full dynamic driver model matched with the stored driver ID, wherein the personalized full dynamic driver model is trained by machine learning; and
calculating the predicted driving range based on the personalized full dynamic driver model.

16. The method of claim 15, further comprising:
training a classification model by one of artificial intelligence and statistical methods based on the plurality of known profiles; and
if the cloud database does not have the stored driver ID for the class of the electrified vehicle, classifying the monitored first set of driver behaviors as one of conservative, neutral, or aggressive, by comparing the first set of driver behaviors to the trained classification model,
wherein modeling the adapted drive cycle profile is further based on the conservative, neutral, or aggressive classification.

17. The method of claim 16, further calculating the predicted driving range based on:
a predicted geospatial route for the electrified vehicle;
road conditions;
traffic conditions; and
environmental conditions.

18. The method of claim 17, if the cloud database does not have the stored driver ID for the class of the electrified vehicle, further comprising:
monitoring a second set of driver behaviors, occurring after the first set of driver behaviors;
comparing the monitored second set of driver behaviors to the known profiles;
updating the modeled adapted drive cycle profile based on the second set of driver behaviors; and
recalculating the predicted driving range based on the updated adapted drive cycle profile.
